(19) United States
(12) Patent Application Publication
(10) Pub. No.: US 2010/0177457 A1
(43) Pub. Date: Jul. 15, 2010

(54) Interdigital capacitor with Self-Canceling Inductance

(76) Inventor: Simon Edward Willard, Irvine, CA (US)

Correspondence Address: LAW OFFICE OF GERALD MALISZEWSKI, P.O. BOX 270829, SAN DIEGO, CA, 92198-2829, US

(21) Appl. No.: 12/351,822

(22) Filed: Jan. 10, 2009

(51) Int. Cl. H01G 4/30

(52) U.S. Cl. 361/301.4

(57) ABSTRACT

An interdigital capacitor is provided with self-canceling inductance. The capacitor is made of a first metal layer including a first set of fingers connected to a first terminal, and a second set of fingers interdigitated between the first set. A second metal layer including a third set of fingers is connected to a second terminal, and a fourth set of fingers interdigitated between the third set. Each finger in the first set is connected to an overlying finger in the fourth set with at least one via. Each finger in the second set is connected to an overlying finger in the third set with at least one via. The second terminal overlies the first terminal.

### BACKGROUND OF THE INVENTION

1. Field of the Invention

This invention generally relates to electrical circuitry components and, more particularly, to an interdigital capacitor with self-canceling inductance for integrated circuit (IC) applications.

2. Description of the Related Art

FIG. 1 is a schematic diagram of a multilayer interdigital capacitor (prior art). Capacitors are useful components in IC circuitry. The use of alternating lines or plates of metal interconnect layers in integrated circuits is common, especially if large values of capacitance are desired. The two terminals, i.e. positive and negative, are spatially separated, usually on opposite or adjacent sides of the capacitor. The interdigital structure provides an improvement in capacitance as compared to a parallel plate structure. However, at high frequencies the depicted interdigital structure develops inductance between adjacent digits. Since the adjacent digits have opposite polarities and are connected to terminals on opposite sides of the structure, ac current in adjacent digits flows in the same direction, creating inductance between the digits. The creation of inductance in a component nominally referred to as a capacitor results in the part having a low Q value and being self-resonant at particular frequencies. All of these characteristics are undesirable in a capacitor. Strategically designing interdigital structures to realize equal currents traveling in opposite directions has not been reported. Strategically placing the two electrical terminals in close proximity in order to allow this strategic design for current flow has not been reported.

It would be advantageous if a large capacitance value component with ideal capacitance characteristics existed for use in an IC at higher frequencies.

It would be advantageous if the above-mentioned capacitor had a self-resonance frequency for capacitance values up to 5 picofarads (pF) above 20 gigahertz (GHz).

### SUMMARY OF THE INVENTION

The present invention minimizes parasitic inductance in an interdigital capacitor made from the interconnect layers of an integrated circuit. Unlike conventional construction, where the two terminals are spatially separated on opposite or adjacent sides of the capacitor, the terminals of the present invention capacitor are in close proximity. The design minimizes the inductance of the device, thereby permitting near ideal operation of the capacitor to much higher frequencies. The design creates equal currents traveling in opposite directions in close proximity throughout the device.

Accordingly, an interdigital capacitor is provided with self-canceling inductance. The capacitor is made of a first metal layer including a first set of fingers connected to a first terminal, and a second set of fingers interdigitated between the first set. A second metal layer including a third set of fingers is connected to a second terminal, and a fourth set of fingers interdigitated between the third set. Each finger in the first set is connected to an overlying finger in the fourth set with at least one via. Each finger in the second set is connected to an overlying finger in the third set with at least one via. The second terminal overlies the first terminal.

Additional details of the above-described capacitor are provided below.

### BRIEF DESCRIPTION OF THE DRAWINGS

FIG. 1 is a schematic diagram of a multilayer interdigital capacitor (prior art).

FIG. 2 is perspective view of an interdigital capacitor with self-canceling inductance.

FIG. 3 is a plan view of the first metal layer of FIG. 2.

FIG. 4 is a plan view of the second metal layer of FIG. 2.

FIG. 5 is a perspective drawing depicting the capacitor of FIG. 2 expanded to four metal layers.

FIG. 6 is a plan view of the first metal layer of FIGS. 2 or 5.

FIG. 7 is a plan view of the first metal layer in a six-layer capacitor.

FIG. 8 is a plan view of the second metal layer depicting current flow.

FIG. 9 is a plan view of the third metal layer depicting current flow.

FIG. 10 is a plan view of the fourth metal layer depicting current flow.

FIG. 11 is a plan view of the fifth metal layer depicting current flow.

FIG. 12 is a plan view of the sixth metal layer depicting current flow.

FIG. 13 is a flowchart illustrating a method for creating capacitance with self-canceling inductance in an interdigital capacitor.

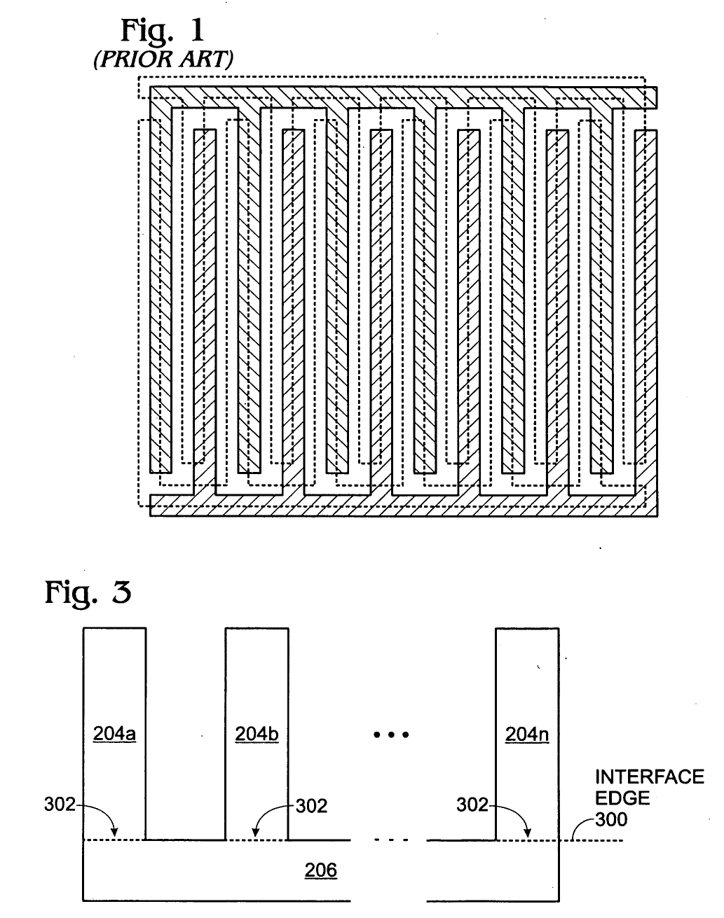

### DETAILED DESCRIPTION

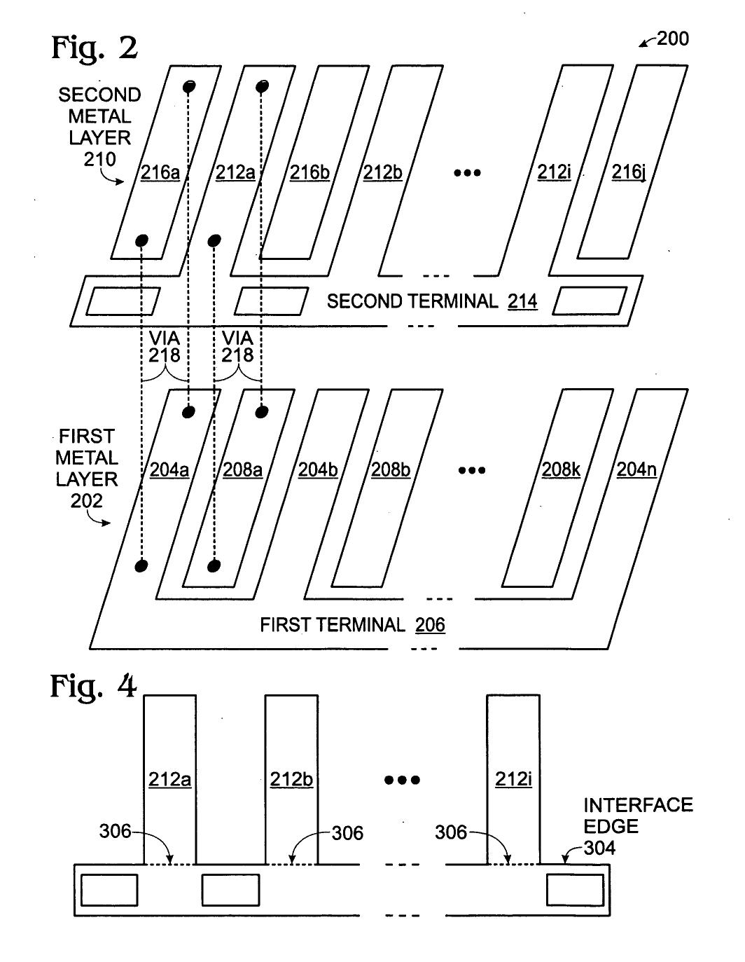

FIG. 2 is perspective view of an interdigital capacitor with self-canceling inductance. The capacitor 200 comprises a first metal layer 202 including a first set of fingers 204 connected to a first terminal 206, and a second set of fingers 208 interdigitated between the first set 204. The first set of fingers is represented by fingers or digits 204a through 204n, where n is not limited to any particular value. The second set of fingers is represented by fingers 208a through 208k, where k is not limited to any particular value.

A second metal layer 210 includes a third set of fingers 212 connected to a second terminal 214, and a fourth set of fingers 216 interdigitated between the third set 212. The third set of fingers is represented by fingers 212a through 212i, where i is not limited to any particular value. The fourth set of fingers is represented by fingers 216a through 216j. Typically, i=n and k=j. An interlevel dielectric layer (not shown) is interposed between the first and second metal layers.

Each finger in the first set 204 is connected to an overlying finger in the fourth set 216 with at least one via 218, represented as a dotted line. In one aspect as shown, each finger in the first and fourth sets is connected with a plurality of vias. For clarity, the vias are not shown for every finger. Each finger in the second set 208 is connected to an overlying finger in the third set 212 with at least one via 218. Typically, each finger in the second and third sets is connected with a plurality of vias 218. The second terminal 214 overlies the first terminal 206.

FIG. 3 is a plan view of the first metal layer of FIG. 2. The first terminal 206 has an interface edge 300. The first set of fingers 204 is aligned in parallel straight lines, perpendicular to the first terminal interface edge 300, with each finger having a proximal end 302 connected to the first terminal interface edge 300.

FIG. 4 is a plan view of the second metal layer of FIG. 2. The second terminal 214 has an interface edge 304. The third set of fingers 212 is aligned in parallel straight lines, perpendicular to the second terminal interface edge 304, with each finger having a proximal end 306 connected to the second terminal interface edge 304. Typically, the second terminal interface edge 304 overlies the first terminal interface edge 300.

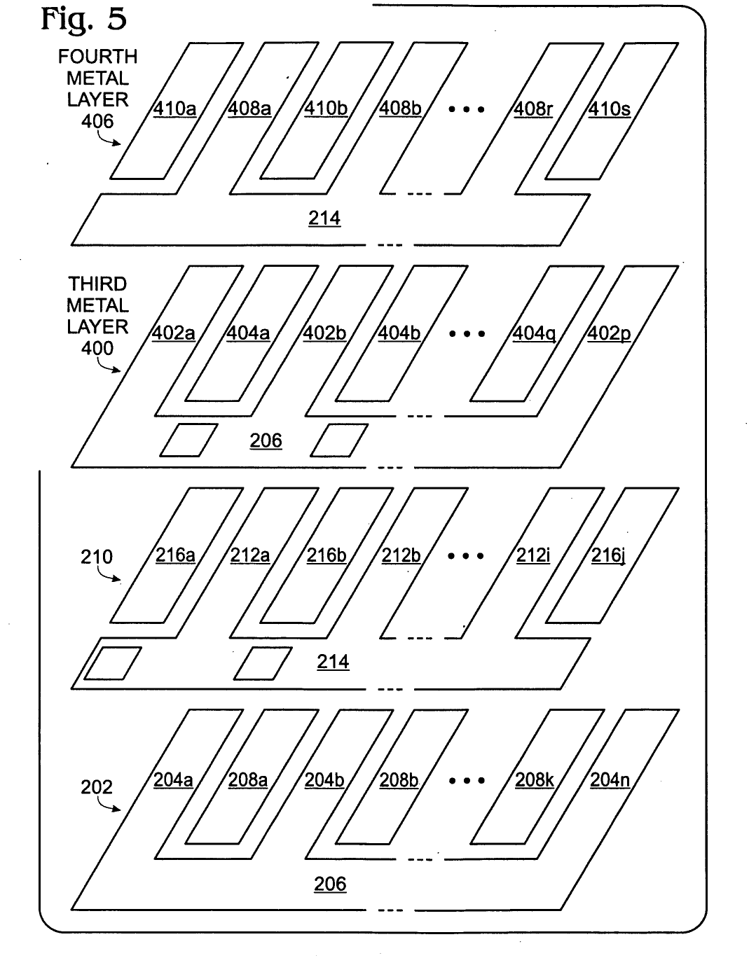

FIG. 5 is a perspective drawing depicting the capacitor of FIG. 2 expanded to four metal layers. A third metal layer 400 including a fifth set of fingers 402 is connected to the first terminal 206, and a sixth set of fingers 404 is interdigitated between the fifth set 402. The fifth set of fingers is represented by finger or digits 402a through 402p, where p is not limited to any particular value. The sixth set of fingers is represented by fingers 404a through 404q, where q is not limited to any particular value.

A fourth metal layer 406 includes a seventh set of fingers 408 connected to the second terminal 214, and an eighth set of fingers 410 interdigitated between the seventh set 408. The seventh set of fingers is represented by finger 408a through 408r, where r is not limited to any particular value. The eighth set of fingers is represented by finger 410a through 410s, where s is not limited to any particular value. Typically, i=n=s and k=j=r. An interlevel dielectric layer (not shown) is interposed between the third and fourth metal layers.

Each finger in the fifth set 402 is connected to an overlying finger in the eighth set 410 with at least one via. Typically however, a plurality of vias connects each finger in the fifth and eighth sets. For clarity, the vias are not shown. Each finger in the sixth set 406 is connected to an overlying finger in the seventh set 408 with at least one via. Typically however, a plurality of vias connects each finger in the sixth and seventh sets. For clarity, the vias are not shown.

The first terminal 206a on the first metal layer 402 is connected to the first terminal 206b on the third metal layer 400 with a plurality of vias (not shown for clarity). The second terminal 214a on the second metal layer 210 is connected to the second terminal 214b on the fourth metal layer 406 with a plurality of vias (not shown for clarity).

In another aspect, each finger in the fifth set 402 is connected to an underlying finger in the fourth set 216 with at least one via. Typically however, a plurality of vias connects each finger in the fourth and fifth sets. For clarity, the vias are not shown. Each finger in the sixth set 404 is connected to an underlying finger in the third set 212 with at least one via. Typically however, a plurality of vias connects each finger in the third and sixth sets. For clarity, the vias are not shown.

Two metal layer and four metal layer designs have been described above. However, it should be understood that the present invention capacitor design is not necessarily limited to any particular number of metal layers. That is, the capacitor may be comprised of a plurality of underlying/overlying metal layers over the second metal layer, where each underlying metal layer includes a set of fingers connected to a terminal on the underlying metal layer. According to this description, the third metal layer 400 of FIG. 5 would be an underlying metal layer, while the fourth metal layer 406 would be the overlying metal layer. The underlying metal layer terminal is connected through vias to the first terminal. The underlying metal layer also includes a set of interdigitated fingers (e.g., sixth finger set 404). Each overlying metal layer includes a set of fingers (e.g., seventh finger set 408) connected to the terminal on the overlying metal and to the underlying metal layer interdigitated fingers through vias. The overlying metal layer terminal is connected through vias to the second terminal. The overlying metal layer also includes a set of interdigitated fingers (e.g., eighth finger set 410) connected through vias to the set of finger on the underlying metal layer.

### Functional Description

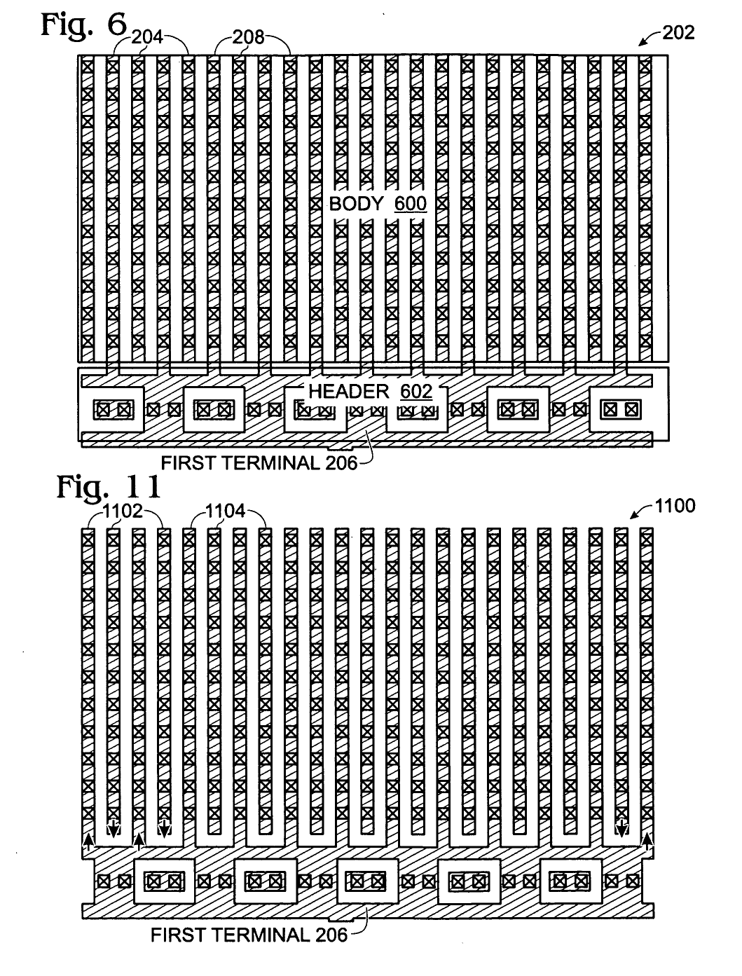

FIG. 6 is a plan view of the first metal layer of FIGS. 2 or 5. As described above, the body 600 of the capacitor is a plurality of lines or plates in the interconnect layers of the integrated circuit, which are also referred to herein as,metal layers. The header 602 of the capacitor consists of the terminals and interconnects to make electrical connections from the terminals to the body. The two terminals of the capacitor are the points where electrical contact is made with external circuitry (not shown).

For an ideal capacitor, the current into one terminal is equal to the current out of the other terminal. The capacitor described herein has equal and opposite currents in close proximity at the device terminals and at all points internal to the device. For each finger with a current, there is an adjacent finger with current flow in the opposite direction, equal in magnitude. Therefore, when the capacitor (or any layer of the capacitor) is considered as a unit, the net current is zero.

The terminals of the capacitor are spaced as close as possible to each other. This maintains the equal, opposite net current flow all the way to the terminals. The header maintains this equal and opposite current flow in connecting the terminals to the fingers.

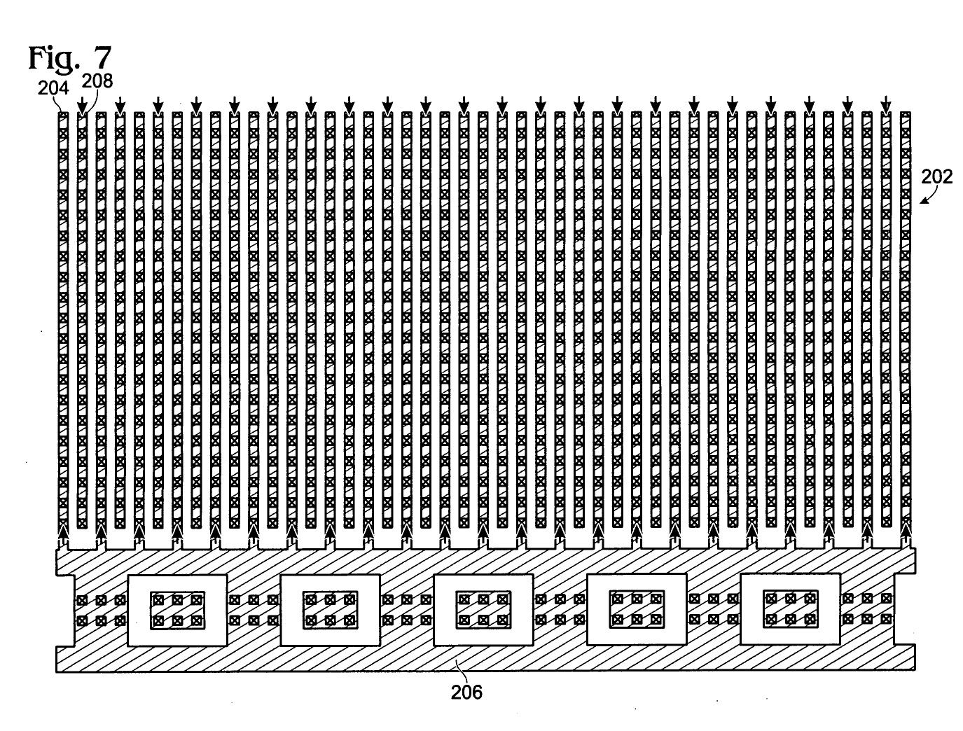

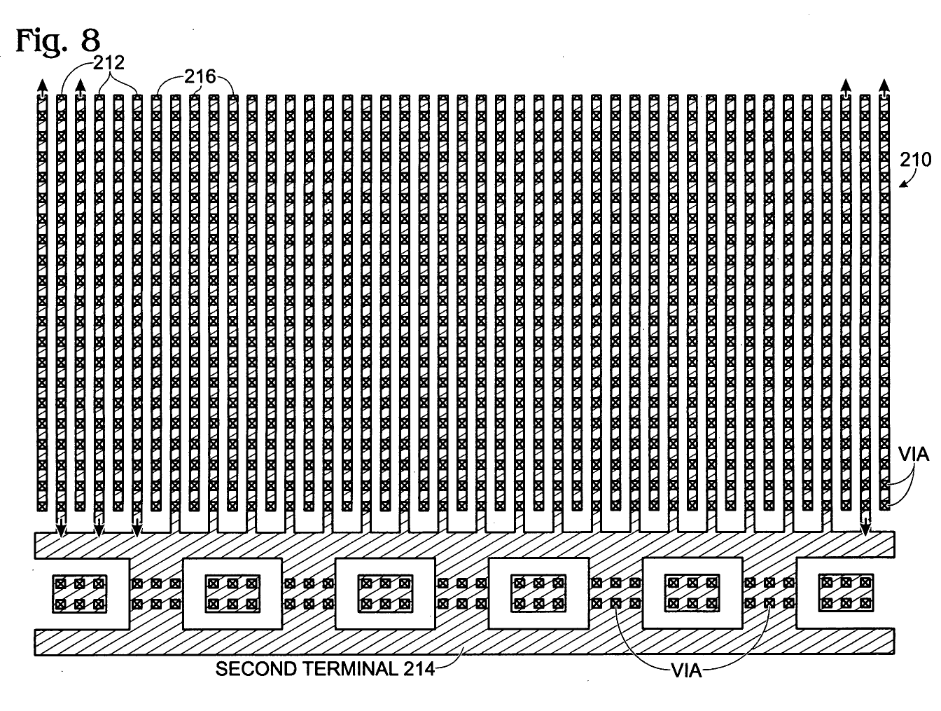

FIG. 7 is a plan view of the first metal layer in a six-layer capacitor. The arrows show the direction of current flow at a first moment in time. Note that current goes in the positive Y direction (“up”) in the odd-numbered fingers (first finger set 204), and flows in the negative Y direction (“down”) for all even-numbered fingers (second finger set 208). While the first metal layer is the lowest level of metal used for the capacitor, it may or may not be the lowest level of metal on the die. The square boxes in the fingers and header region represent vias to the overlying second metal layer (not shown in this figure).

FIG. 8 is a plan view of the second metal layer depicting current flow. Again, the arrows show direction of current flow at the first moment in time and the square boxes represent vias to an overlying metal layer. The second metal layer 210 is the adjacent metal layer above the first metal layer (see FIG. 7). The metal fingers on this level align with the metal fingers of the first metal layer. That is, the first fingers align with the fourth fingers 216, and the second fingers align with the third fingers 212. Note: at the first moment in time current flows in the negative Y direction in the third set of (even-numbered) fingers, and flows in the positive Y direction for all fingers in the fourth set. Each finger is balanced by an adjacent finger with current flow in the opposite direction.

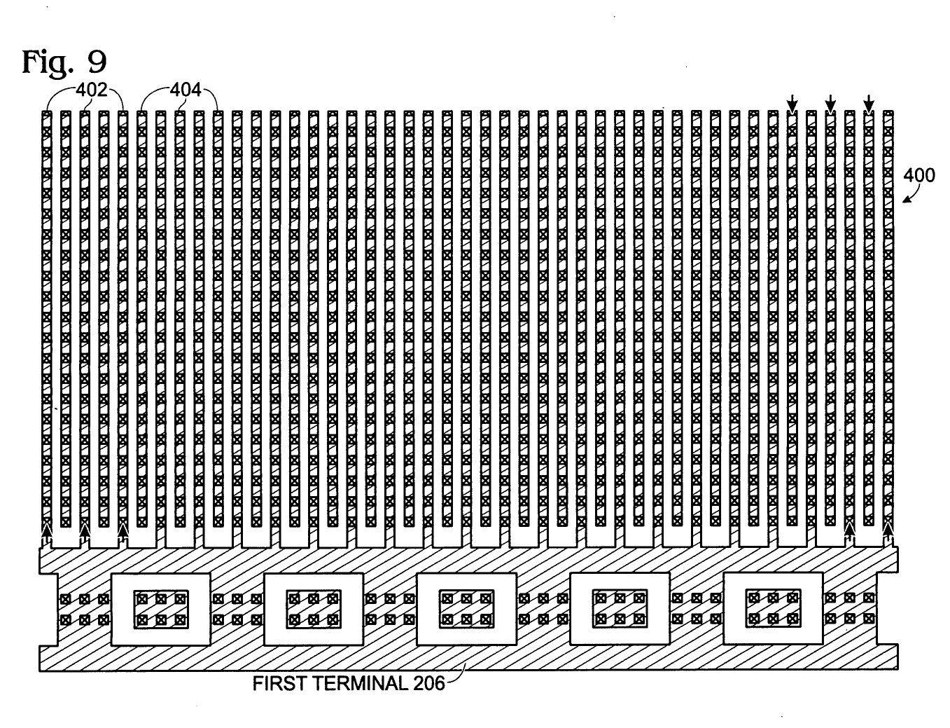

FIG. 9 is a plan view of the third metal layer depicting current flow. The arrows show direction of current at the first moment of time and the square boxes represent vias to an overlying metal layer.

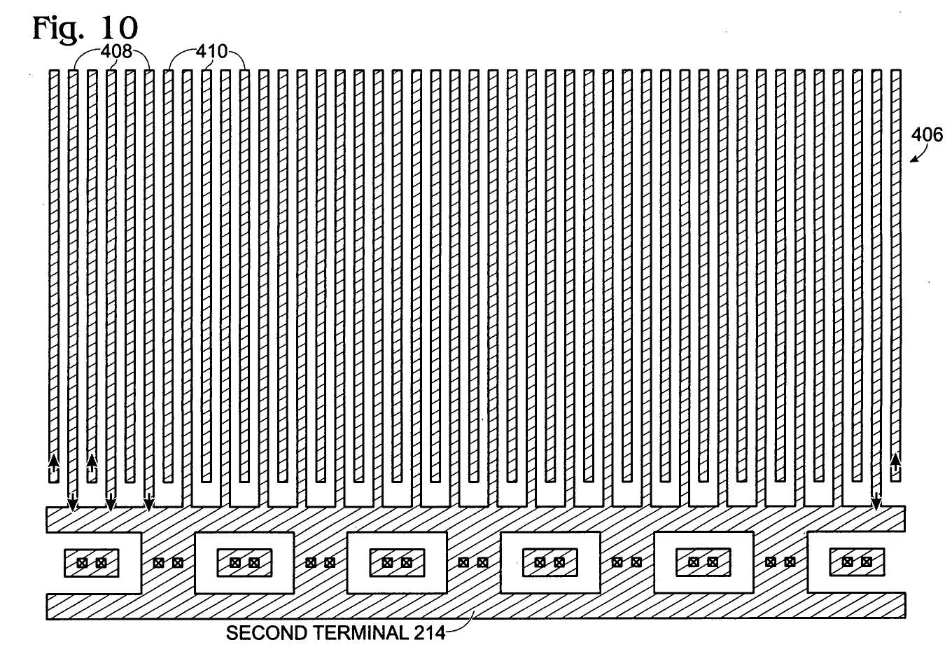

FIG. 10 is a plan view of the fourth metal layer depicting current flow. The arrows show the direction of current at the first moment of time. If the fourth metal layer is the top metal, there are no vias (square boxes) connecting the fourth metal layer to an overlying metal layer. Alternately as shown, if there is an overlying (fifth) metal layer in the capacitor, vias may not be used if the overlying metal layer uses different line widths and/or spacing, so that common electrical polarity fingers in the different metals layer are not vertically aligned.

FIG. 11 is a plan view of the fifth metal layer 1100 depicting current flow. The arrows show the direction of current at the first moment of time through the ninth set of fingers 1102, connected to the first terminal 206, and the tenth set of fingers 1104, connected to the second terminal on the sixth metal layer through vias (the square boxes shown) to overlying fingers.

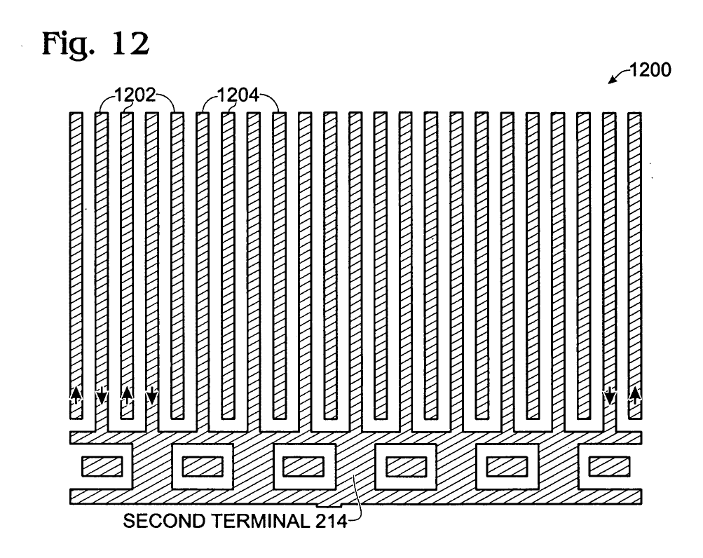

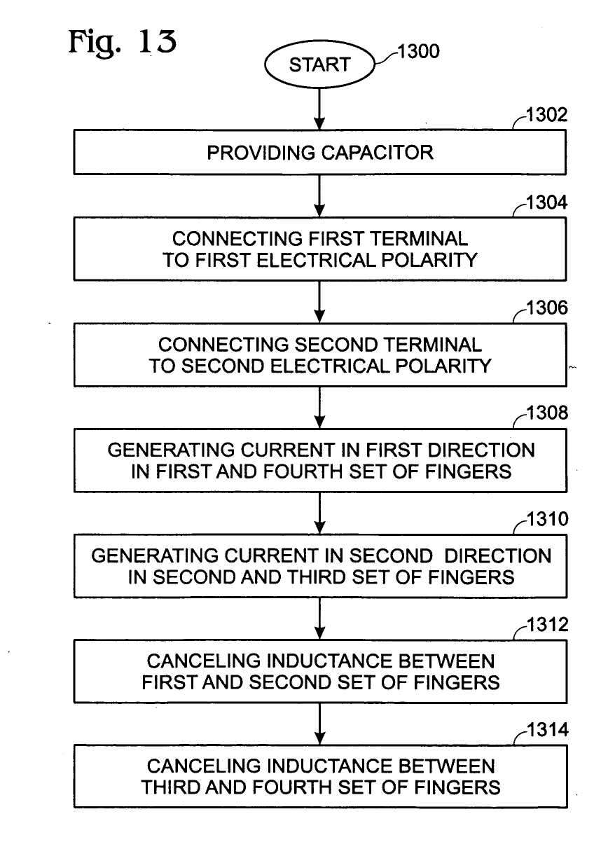

FIG. 12 is a plan view of the sixth metal layer 1200 depicting current flow. The arrows show the direction of current at the first moment of time through the eleventh set of fingers 1202, connected to the second terminal 214, and the twelfth set of fingers 1204, connected to the first terminal on the fifth metal layer through vias to underlying fingers (the ninth set).

FIG. 13 is a flowchart illustrating a method for creating capacitance with self-canceling inductance in an interdigital capacitor. Although the method is depicted as a sequence of numbered steps for clarity, the numbering does not necessarily dictate the order of the steps. It should be understood that some of these steps may be skipped, performed in parallel, or, performed without the requirement of maintaining a strict order of sequence. The method starts at Step 1300.

Step 1302 provides a capacitor as described in FIG. 2, with a first metal layer including a first set of fingers connected to a first terminal, and a second set of fingers interdigitated between the first set. The capacitor has a second metal layer including a third set of fingers connected to a second terminal, and a fourth set of fingers interdigitated between the third set. Each finger in the first set is connected to an overlying finger in the fourth set with vias, and each finger in the second set is connected to an overlying finger in the third set with vias. The second terminal overlies the first terminal.

Step 1304 connects the first terminal to an electrical signal first polarity (e.g., “+”). Step 1306 connects the second terminal to a second polarity of the electrical signal (e.g., “−”), where the second polarity is opposite of the first polarity. In response to the electrical signal, Step 1308 generates current flow in a first direction through the first and fourth set of fingers. Also in response to the electrical signal, Step 1310 generates current flow in a second direction through the second and third set of fingers, opposite to the first direction. In response to the current flows, Step 1312 cancels inductance between the first and second set of fingers. In response to the current flows, Step 1314 cancels inductance between the third and fourth set of fingers.

An interdigital capacitor has been provided with self-canceling inductance. Some examples of layouts and structures have been given to illustrate the invention, but the invention is not limited to just these examples. Other variations of the invention will occur to those skilled in the art.

We claim:

1. An interdigital capacitor with self-canceling inductance, the capacitor comprising:
a first metal layer including a first set of fingers connected to a first terminal, and a second set of fingers interdigitated between the first set;
a second metal layer including a third set of fingers connected to a second terminal, and a fourth set of fingers interdigitated between the third set;
wherein each finger in the first set is connected to an overlying finger in the fourth set with at least one via;
wherein each finger in the second set is connected to an overlying finger in the third set with at least one via; and,
wherein the second terminal overlies the first terminal.

2. The capacitor of claim 1 further comprising:
a third metal layer including a fifth set of fingers connected to the first terminal, and a sixth set of fingers interdigitated between the fifth set;
a fourth metal layer including a seventh set of fingers connected to the second terminal, and an eighth set of fingers interdigitated between the seventh set;
wherein each finger in the fifth set is connected to an overlying finger in the eighth set with at least one via; and,
wherein each finger in the sixth set is connected to an overlying finger in the seventh set with at least one via.

3. The capacitor of claim 2 wherein the first terminal on the first metal layer is connected to the first terminal on the third metal layer with a plurality of vias; and,
wherein the second terminal on the second metal layer is connected to the second terminal on the fourth metal layer with a plurality of vias.

4. The capacitor of claim 2 wherein each finger in the fifth set is connected to an underlying finger in the fourth set with at least one via, and,
wherein each finger in the sixth set is connected to an underlying finger in the third set with at least one via.

5. The capacitor of claim 4 wherein each finger in the fifth set is connected to the underlying finger in the fourth set with a plurality vias; and,
wherein each finger in the sixth set is connected to the underlying finger in the third set with a plurality of vias.

6. The capacitor of claim 1 further comprising:
a plurality of underlying/overlying metal layers over the second metal layer, each underlying metal layer including a set of fingers connected to a terminal on the underlying metal layer, and a set of interdigitated fingers, and each overlying metal layer including a set of fingers connected to a terminal on the overlying metal and to the underlying metal layer interdigitated fingers through vias, and a set of interdigitated finger connected through vias to the set of finger on the underlying metal layer;
wherein each underlying metal layer terminal is connected through vias to the first terminal; and,
wherein each overlying metal layer terminal is connected through vias to the second terminal.

7. The capacitor of claim 1 wherein each finger in the first set is connected to the overlying finger in the fourth set with a plurality of vias; and,
wherein each finger in the second set is connected to the overlying finger in the third set with a plurality of vias.

8. The capacitor of claim 1 wherein the first terminal has an interface edge;
wherein the first set of fingers are aligned in parallel straight lines, perpendicular to the first terminal interface edge, with each finger having a proximal end connected to the first terminal interface edge;
wherein the second terminal has an interface edge; and,
wherein the third set of fingers are aligned in parallel straight lines, perpendicular to the second terminal interface edge, with each finger having a proximal end connected to the second terminal interface edge.

9. The capacitor of claim 8 wherein the second terminal interface edge overlies the first terminal interface edge.

10. The capacitor of claim 1 further comprising:
an interlevel dielectric layer interposed between the first and second metal layers.

11. The capacitor of claim 2 further comprising:
an interlevel dielectric layer interposed between the third and fourth metal layers.

12. In an interdigital capacitor, a method for creating capacitance with self-canceling inductance, the method comprising:
providing a capacitor with a first metal layer including a first set of fingers connected to a first terminal, and a second set of fingers interdigitated between the first set, a second metal layer including a third set of fingers connected to a second terminal, and a fourth set of fingers interdigitated between the third set, where wherein each finger in the first set is connected to an overlying finger in the fourth set with vias and where each finger in the second set is connected to an overlying finger in the third set with vias, and where the second terminal overlies the first terminal;
connecting the first terminal to an electrical signal first polarity;
connecting the second terminal to a second polarity of the electrical signal, where the second polarity is opposite of the first polarity:
in response to the electrical signal, generating current flow in a first direction through the first and fourth set of fingers;
in response to the electrical signal, generating current flow in a second direction through the second and third set of fingers, opposite to the first direction.

13. The method of claim 12 further comprising:
in response to the current flows, canceling inductance between the first and second set of fingers; and,
in response to the current flows, canceling inductance between the third and fourth set of fingers.
